(19) United States
(12) Patent Application Publication
(10) Pub. No.: US 2014/0141311 A1
(43) Pub. Date: May 22, 2014

(54) RECHARGEABLE ELECTRIC BATTERY

(71) Applicant: Martin Michelitsch, Kumberg (AT)

(72) Inventor: Martin Michelitsch, Kumberg (AT)

(21) Appl. No.: 14/129,977

(22) PCT Filed: Jun. 26, 2012
(86) PCT No.: PCT/EP2012/062338

§ 371 Date: Feb. 5, 2014

(30) Foreign Application Priority Data
Jun. 30, 2011 (AT) A 957/2011

(51) Int. Cl. H01M 10/04; H01M 10/42; H01M 10/60

(52) U.S. Cl. CPC H01M 10/0413; H01M 10/50; H01M 10/4207
USPC 429/120; 429/156

(57) ABSTRACT

A rechargeable electric battery or a high-voltage battery, for an electric vehicle, having at least two stacks of battery cells arranged side-by-side in a line in the direction of stacking The stacks are arranged side-by-side and transversely to the direction of stacking, with at least two stacks arranged side-by-side being arranged offset relative to each other in the direction of stacking.

### CROSS-REFERENCE TO RELATED APPLICATIONS

The present application is a National Stage Application of PCT International Application No. PCT/EP2012/062338 (filed on Jun. 26, 2012), under 35 U.S.C. §371, which claims priority to Austrian Patent Application No. A 957/2011 (filed on Jun. 30, 2011), which are each hereby incorporated by reference in their respective entireties.

### TECHNICAL FIELD

Embodiments relate to a rechargeable electric battery, in particular, a high-voltage battery, preferably for an electric vehicle, with at least two stacks of battery cells arranged side-by-side in a line in the direction of stacking, with the stacks arranged side-by-side and transversely to the direction of stacking, with at least two stacks arranged side-by-side being arranged offset relative to each other in the direction of stacking

### BACKGROUND

Battery packs, consisting of a plurality of lithium-ion battery cells, contain in addition to these a series of other subsystems such as cell fastening systems, cell cooling systems, cell monitoring systems, cell connection systems or the like. The integration of these subsystems requires additional installation space that far exceeds the volume encompassed by the cell chemistry. It has a negative effect on the volumetric energy density, which is already lower than for fossil fuels.

Empty spaces are created when a plurality of cells are located side-by-side due to the structural form of the many various known lithium-ion pouch cells where the plastic cell casings are sealed by way of a continuous lateral sealing seam running around the active cell chemistry. These enclosed spaces are difficult to utilise technically as they can only be dimensioned very roughly as a result of production tolerances of the battery cells, sometimes splitting into individual spaces due to the protruding sealing seams.

German Patent Publication No. DE 10 2009 035 463 A1 discloses a battery with a plurality of flat, essentially plate-shaped individual battery cells. The individual battery cells are stacked to form a stack of cells and surrounded by a battery housing. The individual cells of the battery are developed in a flat, framed manner with metal sheets and a frame of insulating material.

WO 2008/048751 A2 also discloses a battery module with a plurality of plate-shaped battery cells arranged side-by-side in a stack that are accommodated in a housing.

WO 2010/053689 A2 discloses a battery arrangement with a housing and a plurality of lithium-ion cells that are arranged side-by-side. A thermally conductive, electrically insulating fluid flows through the housing for cooling purposes.

WO 2010/067 944 A1 discloses a battery with stacks of battery cells arranged side-by-side, with battery cells being cooled by cooling air.

Japanese Patent Publication No. JP 2007-109546 A discloses a rechargeable battery with two battery modules arranged side-by-side that are offset with respect to each other in the stacking direction.

### SUMMARY

The object of embodiments is to avoid the given disadvantages and to improve the volumetric energy density for an electric battery of the type mentioned at the outset.

In accordance with embodiments, this is achieved by at least one battery cell of a stack being arranged at least partially overlapping at least one battery cell of an adjacent stack. The offset of the two stacks is about half the thickness of a battery cell. This facilitates denser packing.

In order to utilise the remaining cavities, at least a first cooling air channel can be developed between at least one overlapping area of the battery cells of adjacent stacks.

At least one battery cell is encapsulated by a plastic cell casing, with the plastic cell casing having a protruding sealing seam, preferably in the area of a cell middle plane, arranged to run along the narrow side of the battery cell. A space is defined between the sealing seams of adjacent battery cells of a stack in each case. This space can form a first and/or second cooling air channel. In this context, at least one first cooling air channel can be arranged in the direction of a vertical axis of the battery and at least a second cooling air channel in the direction of a transverse axis of the battery that is developed at a right angle to the vertical axis and to the stacking direction.

In order to facilitate easy production it is advantageous if two stacks with partially overlapping battery cells form one battery module in each case, preferably with each battery module arranged between two preferably thermal and/or electrical insulating plates.

The air flows through and cools the region between the two adjacent stacks via the first cooling air channel. The second cooling air channels conducting the flow of cooling air are arranged on the upper side of the battery and serve to cool the cell terminals and/or the electrical cell connectors. The latter can be cooled particularly well when at least one cell connector, provided with preferably one U-shaped or Y-shaped profile or cross-section for electrically connecting two adjacent battery cells, projects into a second cooling air channel. The first and/or second cooling air channels can be part of a closed cooling air circuit for cooling the battery, preferably with the cooling air circuit having at least one cooling air fan and at least one heat exchanger. The closed cooling air circuit allows for the battery to be cooled largely free of disadvantageous environmental influences such as fluctuations in temperature and moisture, air pollution, or similar. This ensures constant optimal operating conditions for the battery and facilitates a long service life for it.

At least one sealing seam of a battery cell of a first stack can project into a space defined by the sealing seams of two adjacent battery cells of a second stack. The seal seams bordering the space or projecting into the space create guide surfaces for the cooling air flow. In this manner, on the one hand the conveyance of cooling air is improved and on the other, the surface touched by the cooling area is enlarged.

In order to prevent thermal overheating of adjacent battery cells as far as possible, provision is made for a thermal and electrical insulating layer to be arranged between two adjacent battery cells of at least one stack, preferably with the insulating layer formed by an insulating foil.

The requisite installation space can be reduced and the volumetric energy density can be increased as a result of the measures described.

### DRAWINGS

Embodiments will be explained below by reference to the drawings, wherein:

FIG. 1 illustrates a battery in accordance with embodiments in an oblique view from above.

FIG. 2 illustrates the battery in cross-section corresponding to the line II-II in FIG. 1.

FIG. 3 illustrates the battery in a frontal view.

FIG. 4 illustrates the battery in an oblique view from below

FIG. 5 illustrates a battery module of the battery in an oblique view.

FIG. 6 illustrates this battery module in an oblique view from below.

FIG. 7 illustrates a stack of battery cells in an oblique view.

FIG. 8 illustrates this stack in a side view.

FIG. 9 illustrates the stack of battery cells of a battery module in an oblique view.

FIG. 10 illustrates a battery module in cross-section corresponding to line X-X in FIG. 9.

FIG. 11 illustrates a detail of this battery module in cross-section similar to FIG. 10.

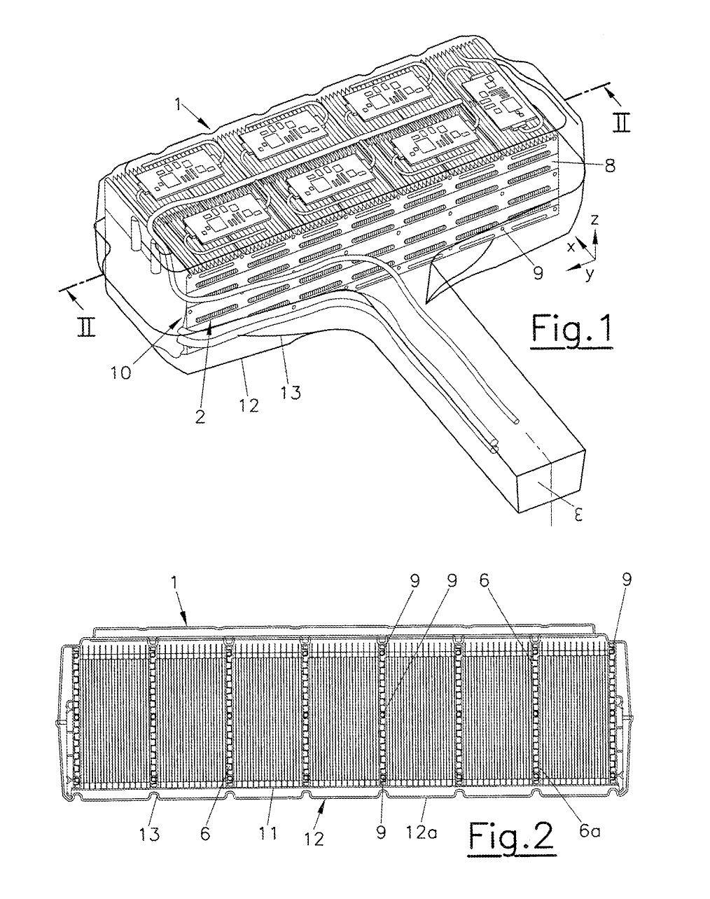

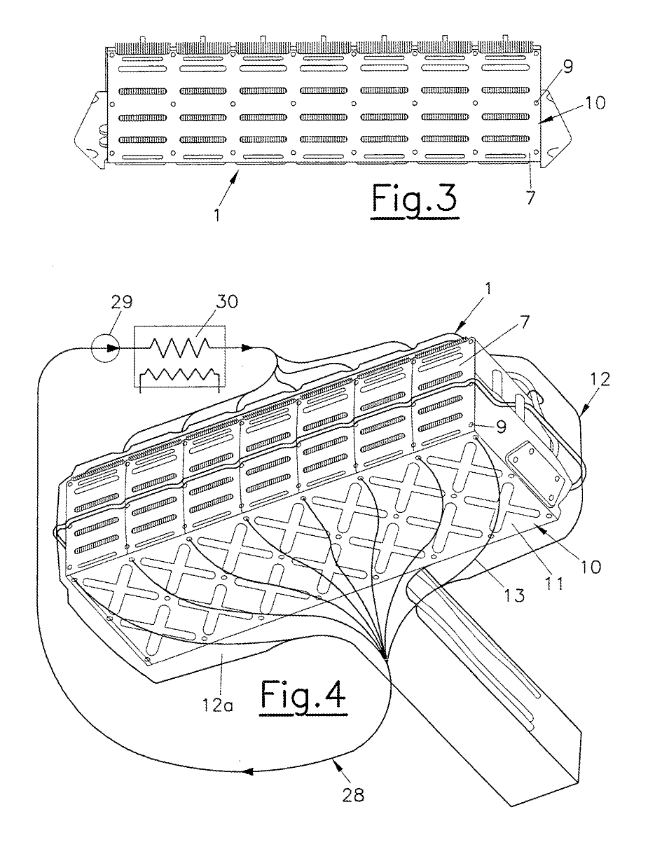

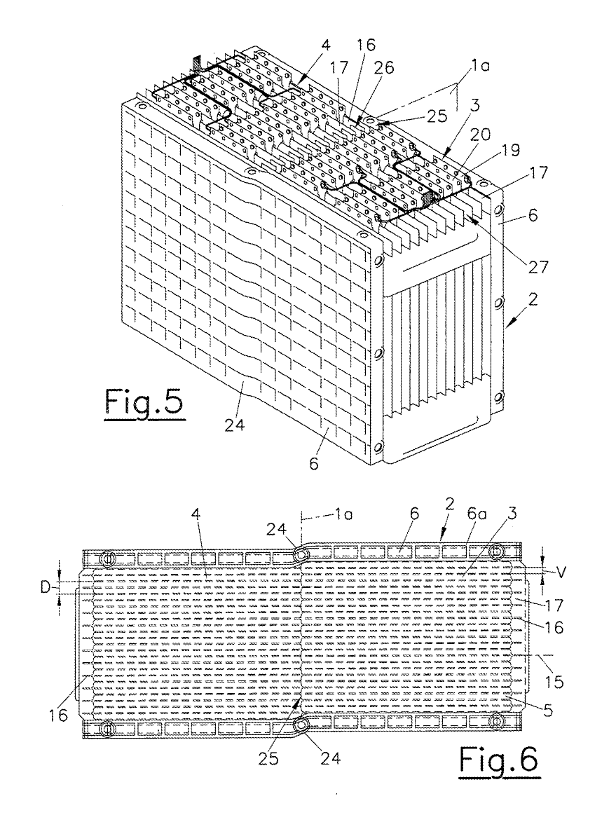

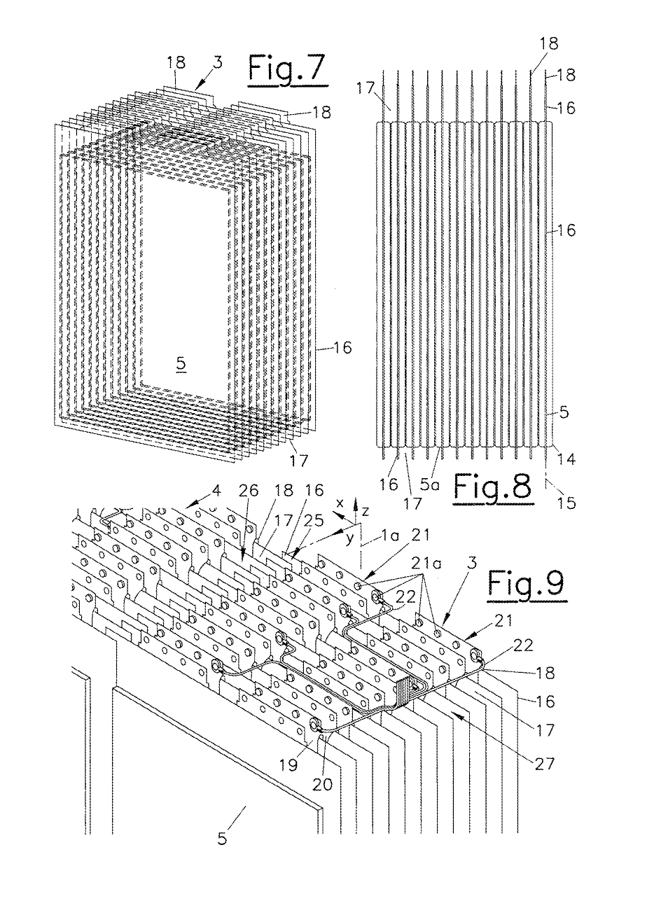

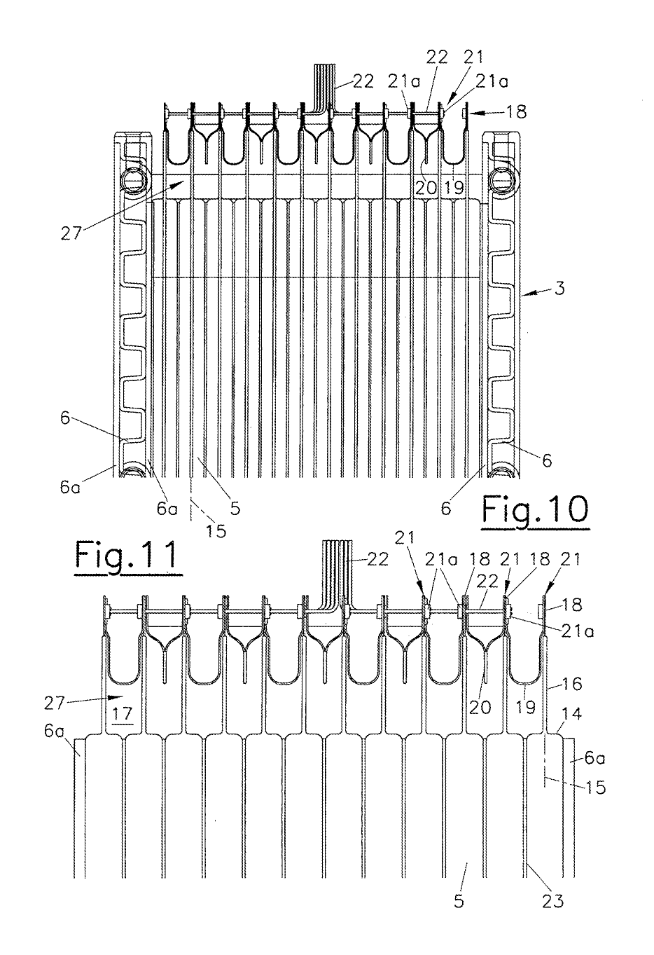

### DESCRIPTION

The rechargeable battery 1 in accordance with embodiments is provided with a plurality, such as, for example seven, battery modules 2, with each battery module 2 having two stacks 3, 4 of fastened battery cells 5 arranged side-by-side. The stacks 3, 4 of each battery module 2 are arranged between two structurally stiff corrugated plates 6 made of, for example aluminium, or plastic, where the plates 6 can be developed from die cast parts. The plates 6 themselves are fixed between two retaining plates 7, 8 on the front and rear sides of the battery 1, with the retaining plate 7 on the front side being firmly connected to the retaining plate 8 on the rear side by way of locking screws 9. The locking screws 9 are arranged in the region of the plates 6. Together with the retaining plates 7, 8, the plates 6 form a holding frame 10 for the battery modules 2. The retaining plates 7, 8 are provided with openings in order to keep the weight as minimal as possible. The gap, viewed in stacking direction y, defined between the locking screws 9 ensures that the battery cells 5 are installed in the correct position and with a specified pretensioned force that is essentially constant for the service life of the battery 1. An elastic insulation layer 6a, made for example from a foam, is arranged between each of the plates 6 and the adjacent battery cells 5, allowing for the pressure to be distributed evenly and gently. The battery 1 is sealed from below by the bottom plate 11.

The battery 1 including the mounting frame 10 is arranged in a housing 12, with cooling air flow paths developed between the housing 12 and the battery 1. In order to guide the flow of cooling air, flow guide surfaces 13 are integrated into the housing floor 12a, as illustrated in FIGS. 2 and 4.

Each battery cell 5 is encapsulated by a plastic casing 14, with the plastic casing 14 having a protruding sealing seam 16 for sealing purposes running along the narrow side 5a roughly in the area of a cell middle plane 15. A space 17 is defined between the sealing seams 16 of adjacent battery cells 5 of a stack 3, 4 in each case.

In order to save installation space, the two stacks 3, 4 of each battery module 2, which are arranged side-by-side, are developed to overlap and be offset in relation to each other. The offset V is about half the thickness D of a battery cell 5. The sealing seams 16 of a battery cell 5 of the one stack 3, 4 project into a space 17 defined by the sealing seams 16 of two adjacent battery cells 5 of the other stack 4, 3. In this manner the space 17 can be used at least partially by accommodating a part of the sealing seam 16. This has a very advantageous effect on the constructed space and on the volumetric energy density. The offset V between the two stacks 3, 4 means that the plates 6 develop a step 24 in the area of a longitudinal middle plane 1a of the battery 1.

Cell terminals 18, connected to each other via cell connectors 19, 20 having a U-shaped or Y-shaped profile or cross-section, project from the plastic casings 14 on the upper narrow side 5a. The connection between the cell connectors 19, 20 and the cell terminals 18 can be developed as a clinch connection 21 provided with one or a plurality of clinch points 21a in a clinching process. This facilitates a particularly high current carrying capability as a result of multiple connecting points as well as a long-term anti-corrosion connection owing to the airtight encapsulated connection points and simple contacting of the cell terminals 18 with different materials (copper to aluminium and vice versa), without additional structural elements. Two to four sheets can be connected to each other electrically with the same tool by way of clinching, with the materials copper, aluminium and steel being particularly suitable with wall thicknesses from 0.1 mm to 0.5 mm. Consequently, if required, cell voltage monitoring cables 22 can be connected to the cell terminals 18 with the cell connectors 19, 20 at the same time in a further operation in a clinching process. As the position of the clinch points 21a of the clinch connection 21 is allowed to vary more than for example is the case for a laser welded connection, a relatively large tolerance compensation capability results. The use of parallel and multipurpose tools allows simpler and cost-effective production for larger production runs, with only a few easily controllable input variables such as material wall thicknesses, press force etc. involved. The clinch points 21a protruding into the cooling air channel 27 increase the heat dissipating surface area of the battery 1, a fact of particular significance in the case of direct air cooling of the cell terminals 18. The projecting clinch points 21a also contribute to increasing turbulence, something that improves heat transfer, particularly in the case of air cooling. Consequently, the positive effect of the clinch points 21a on the cooling also contributes to the increase in the volumetric energy density as a result of efficient utilisation of installation space.

In order to achieve an especially good volumetric energy density, it is necessary to position the battery cells 5 as close to each other as possible. In addition, a thermal and electrical insulating layer 23, for example an insulation foil, which is as thin as possible, is arranged between the battery cells 5 in order to prevent the occurrence of a “domino effect” in the event of thermal overloading of an adjacent battery cell 5.

At the same time, the spaces 17 create the cooling air channels 26, 27. The spaces 17 form first cooling air channels 26 in the region of the overlap 25 of the two stacks 3, 4, i.e. in the region of the longitudinal middle plane la of the battery 1, with said channels arranged in the direction of the vertical axis z of the battery 1. The sealing seams 16 form flow guide surfaces for the stream of air and the heat dissipating surfaces. Second cooling air channels 27 are formed in the region of the cell terminals 18 by the spaces 17 on the upper side of the battery cells 5 in the direction of a transverse axis x at a right angle to the vertical axis z and to the direction of stacking y.

The first and second cooling air channels 26, 27 are part of a closed cooling air circuit 28 for cooling the battery 1, with the cooling air circuit 28 having at least one cooling air fan 29 and at least one heat exchanger 30. The cooling air—coming from the cooling air fan 29 and the heat exchanger 30—is conveyed into the housing 12 in the region of the retaining plate 9 at the rear and/or top of the battery 1 or in the region of the cell terminals 18. The cooling air flows through the second cooling air channels 27 and cools the cell terminals 18 and the cell connectors 19, 20. After this at least a portion of the cooling air reaches the first cooling air channels 26, which guide the cooling air downward in the direction of the vertical axis z. Air flows through all cavities and spaces 17 of the battery 1 and the accumulated heat extracted. The remaining cooling air flows between the retaining plate 8 on the front side of the battery 1 and the housing 12 to the housing floor 12a of the housing 12, where it is guided by the flow guide surfaces 13 to the vehicle's longitudinal middle plane ε and collected. The cooling air is then drawn in again by the cooling air fan and cooled in the heat exchanger 30, before it is fed into the closed cooling circuit 28 of the battery 1 again.

1-13. (canceled)

14. A rechargeable electric battery for an electric vehicle, comprising:
at least two stacks of battery cells arranged side-by-side in a line in a direction of stacking, with the stacks arranged offset relative to each other, side-by-side and transversely relative to the direction of stacking, wherein at least one battery cell of a stack is arranged at least partially overlapping at least one battery cell of an adjacent stack; and
a cell casing, composed of a plastic material, to encapsulate at least one battery cell, the cell casing having a protruding sealing seam arranged to extend along a narrow side of the battery cell, with a space defined between each sealing seams of adjacent battery cells of a stack.

15. The rechargeable electric battery of claim 14, wherein the offset of the two stacks comprises about half the thickness of a battery cell.

16. The rechargeable electric battery of claim 15, further comprising at least one first cooling air channel adjacent to the overlap.

17. The rechargeable electric battery of claim 16, wherein the protruding sealing seam is provided adjacent to an area of a cell middle plane and arranged to extend along the narrow side of the battery cell.

18. The rechargeable electric battery of claim 17, further comprising a first air channel and/or second cooling air channel in at least one space.

19. The rechargeable electric battery of claim 18, wherein:
at least the first cooling air channel is arranged in a direction of a vertical axis of the rechargeable battery; and
at least the second cooling air channel is arranged in a direction of a transverse axis of the rechargeable battery and extends at a right angle to the vertical axis and at a right angle to the direction of stacking.

20. The rechargeable electric battery of claim 14, wherein the at least one sealing seam projects into a space defined by the sealing seams of adjacent battery cells of the other stack.

21. The rechargeable electric battery of claim 14, further comprising a thermal and electrical insulation layer arranged between adjacent battery cells of at least one stack, wherein with the thermal and electrical insulating layer comprises an insulating foil.

22. The rechargeable electric battery of claim 14, wherein at least one space defined by the sealing seams of adjacent battery cells of the other stack forms a cooling air channel, the seal seams project into the space to form guide surfaces for a flow of cooling air.

23. The rechargeable electric battery of claim 22, further comprising at least one cell connector, having a U-shaped or Y-shaped cross-section, which electrically connects adjacent battery cells and which projects into a second cooling air channel.

24. The rechargeable electric battery of claim 14, further comprising a first cooling air channel and/or second cooling air channel which form a closed cooling air circuit to cool the rechargeable battery, wherein the cooling air circuit has at least one cooling air fan and at least one heat exchanger.

25. The rechargeable electric battery of claim 14, wherein each adjacent stacks with partially overlapping battery cells form a battery module, with each battery module arranged between a pair of thermal and/or electrical insulating plates.

26. The rechargeable electric battery of claim 25, wherein the thermal and/or electrical insulating plates have a step adjacent to the overlap.
